(19) United States
(12) Patent Application Publication
(10) Pub. No.: US 2026/0223138 A1
(43) Pub. Date: Jul. 30, 2026

(54) SIDELINK LOGICAL CHANNEL PRIORITIZATION (LCP) PROCEDURE BASED ON A SHARED CHANNEL OCCUPANCY TIME (COT)

(71) Applicant: LENOVO (SINGAPORE) PTE. LTD., Singapore (SG)

(72) Inventors: Joachim LÖHR, Wiesbaden (DE); Alexander Golitschek Edler von Elbwart, Darmstadt (DE); Karthikeyan GANESAN, Nauheim (DE); Prateek BASU MALLICK, Dreieich (DE)

(21) Appl. No.: 19/152,565

(22) PCT Filed: Apr. 3, 2024
(86) PCT No.: PCT/IB2024/053252

§ 371 Date: Jul. 31, 2025

Related U.S. Application Data
(60) Provisional application No. 63/494,103, filed on Apr. 4, 2023.

(51) Int. Cl. H04W 72/25; H04W 72/115; H04W 74/0808

(52) U.S. Cl. CPC H04W 72/25; H04W 72/115; H04W 74/0808

(57) ABSTRACT

Various aspects of the present disclosure relate to channel occupancy time (COT) sharing for sidelink communications over unlicensed channels. For example, the systems and methods described herein enable an efficient sidelink LCP procedure by implementing an LCP procedure for sidelink communications that is based on received COT sharing indications. The LCP procedure may identify and utilize sidelink logical channels of a shared COT based on a received indication of the shared COT and transmit data via the shared COT using the sidelink logical channels that satisfy the LCP procedure conditions. Further, by receiving the indication of the shared COT, the UE may perform a type 2 LBT procedure when accessing the shared channel.

### TECHNICAL FIELD

This application claims priority to U.S. Provisional Patent Application No. 63/494,103, filed on Apr. 4, 2023, entitled SIDELINK LOGICAL CHANNEL PRIORITIZATION (LCP) PROCEDURE BASED ON A SHARED OCCUPANCY TIME (COT), which is incorporated by reference in its entirety.

### TECHNICAL FIELD

The present disclosure relates to wireless communications, and more specifically to sharing a channel occupancy time (COT) for an unlicensed sidelink channel.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In some cases, network communication devices and/or user communication devices of the wireless communications system may utilize unlicensed channels or bands, such as those provided by unlicensed carriers for wireless communications. Under NR-U, or New Radio-Unlicensed applications, a communication device may access an unlicensed channel for downlink and/or uplink transmissions after performing a listen-before-talk (LBT) procedure.

The communication device, such as a UE, may perform the LBT procedure by sensing the unlicensed channel for any ongoing communications within the channel (e.g., detects energy levels of sub-bands within the channel). For example, the UE (or a gNB) can initiate a channel occupancy time (COT) of the channel, which defines a time period within which the UE may communicate over the channel, by performing an LBT procedure (e.g., a category Type 1 or Type 2 procedure) and determining the channel is available for access.

In various scenarios, a UE communicates (or intends to communicate) with other UEs over a communication link called a sidelink. As the usage of such scenarios expands to additional use cases (e.g., commercial use cases), a wireless communication system may seek to increase sidelink data rates and/or support new or additional carrier frequencies for sidelink. The utilization of unlicensed spectrum can assist in achieving these objectives, providing a network with increased data rates and additional frequencies for sidelink communications.

### SUMMARY

The present disclosure relates to methods, apparatuses, and systems that support COT sharing for sidelink communications over unlicensed channels. For example, the systems and methods described herein enable an efficient sidelink LCP procedure by implementing an LCP procedure for sidelink communications that is based on received COT sharing indications. The LCP procedure may identify and utilize sidelink logical channels of a shared COT based on a received indication of the shared COT and transmit data via the shared COT using the sidelink logical channels that satisfy the LCP procedure conditions. Further, by receiving the indication of the shared COT, the UE may perform a type 2 LBT procedure when accessing the shared channel.

Some implementations of the method and apparatuses described herein may further include a UE, comprising at least one memory, and at least one processor coupled with the at least one processor and configured to cause the UE to: receive an indication of a shared channel occupancy time (COT) from a COT initiating UE identified by a first identifier, initiate a sidelink communication over a sidelink channel with a set of other UEs over an unlicensed band associated with the shared COT, and perform a logical channel prioritization (LCP) procedure that comprises generating a sidelink transport block to be transmitted to the set of other UEs over the sidelink channel, wherein the sidelink transport block comprises media access channel service data units (MAC SDUs) of one or more sidelink logical channels; and wherein the LCP procedure utilizes sidelink logical channels of the one or more sidelink logical channels having an associated channel access priority class (CAPC) value that is equal to or smaller than a threshold CAPC value, and an associated destination identifier that matches the first identifier of the COT initiating UE.

In some implementations of the method and apparatuses described herein, the UE receives the threshold CAPC value from COT sharing information within the indication of the shared COT.

In some implementations of the method and apparatuses described herein, the sidelink logical channels considered during the LCP procedure are associated with CAPC values that are equal to or smaller than the threshold CAPC value.

In some implementations of the method and apparatuses described herein, the UE performs the LCP procedure based at least in part on the destination identifier of the sidelink logical channels utilized during the LCP procedure.

In some implementations of the method and apparatuses described herein, the utilized sidelink logical channels include sidelink traffic channels (STCH(s)).

In some implementations of the method and apparatuses described herein, each associated CAPC value for a logical channel is based on delay requirements of the logical channel.

In some implementations of the method and apparatuses described herein, the UE initiates the sidelink channel with the set of other UEs by selecting a sidelink grant.

Some implementations of the method and apparatuses described herein may further include a method performed by a UE, the method comprising receiving an indication of a shared COT from a COT initiating UE identified by a first identifier, initiating a sidelink communication over a sidelink channel with a set of other UEs over an unlicensed band associated with the shared COT, and performing a logical channel prioritization (LCP) procedure that comprises generating a sidelink transport block to be transmitted to the set of other UEs over the initiated sidelink channel, wherein the sidelink transport block comprises MAC SDUs of one or more sidelink logical channels and wherein the LCP procedure utilizes sidelink logical channels of the one or more sidelink logical channels having an associated CAPC value that is equal to or smaller than a threshold CAPC value, and an associated destination identifier that matches the first identifier of the COT initiating UE.

In some implementations of the method and apparatuses described herein, the UE receives the threshold CAPC value from COT sharing information within the indication of the shared COT.

In some implementations of the method and apparatuses described herein, the sidelink logical channels considered during the LCP procedure are associated with CAPC values that are equal to or smaller than the threshold CAPC value.

In some implementations of the method and apparatuses described herein, the UE performs the LCP procedure based at least in part on the destination identifier of the sidelink logical channels utilized during the LCP procedure.

In some implementations of the method and apparatuses described herein, the utilized sidelink logical channels include STCH(s).

In some implementations of the method and apparatuses described herein, each associated CAPC value for a logical channel is based on delay requirements of the logical channel.

In some implementations of the method and apparatuses described herein, the UE initiates the sidelink channel with the set of other UEs by selecting a sidelink grant.

Some implementations of the method and apparatuses described herein may further include a UE, comprising at least one memory, and at least one processor coupled with the at least one processor and configured to cause the UE to initiate a COT over an unlicensed band for sidelink communications between a set of UEs, and transmit an indication of a shared COT to a recipient UE of the set of UEs, wherein the indication of the shared COT comprises COT sharing information, including an identifier of the UE and a threshold CAPC value for sidelink logical channels utilized by the recipient UE during an LCP procedure over the shared COT.

In some implementations of the method and apparatuses described herein, the UE transmits the indication of the shared COT via radio resource control (RRC) signaling.

Some implementations of the method and apparatuses described herein may further include a method performed by a UE, the method comprising initiating a COT over an unlicensed band for sidelink communications between a set of UEs, and transmitting an indication of a shared COT to a recipient UE of the set of UEs, wherein the indication of the shared COT comprises COT sharing information, including an identifier of the UE, and a threshold CAPC value for sidelink logical channels utilized by the recipient UE during a LCP procedure over the shared COT.

In some implementations of the method and apparatuses described herein, the UE transmits the indication of the shared COT via RRC signaling.

Some implementations of the method and apparatuses described herein may further include a processor for wireless communication, comprising at least one controller coupled with at least one memory and configured to cause the processor to receive an indication of a shared COT from a COT initiating UE identified by a first identifier, initiate a sidelink communication over a sidelink channel with a set of other UEs over an unlicensed band associated with the shared COT, and perform an LCP procedure that comprises generating a sidelink transport block to be transmitted to the set of other UEs over the sidelink channel, wherein the sidelink transport block comprises MAC SDUs of one or more sidelink logical channels; and wherein the LCP procedure utilizes sidelink logical channels of the one or more sidelink logical channels having: an associated CAPC value that is equal to or smaller than a threshold CAPC value, and an associated destination identifier that matches the first identifier of the COT initiating UE.

In some implementations of the method and apparatuses described herein, the processor receives the threshold CAPC value from COT sharing information within the indication of the shared COT.

In some implementations of the method and apparatuses described herein, the sidelink logical channels considered during the LCP procedure are associated with CAPC values that are equal to or smaller than the threshold CAPC value.

In some implementations of the method and apparatuses described herein, the processor performs the LCP procedure based at least in part on the destination identifier of the sidelink logical channels utilized during the LCP procedure.

### BRIEF DESCRIPTION OF THE DRAWINGS

FIG. 1 illustrates an example of a wireless communications system that supports COT sharing for an unlicensed sidelink channel in accordance with aspects of the present disclosure.

FIG. 2 illustrates an example of a wireless communications system that supports performing an LCP procedure over a shared COT in accordance with aspects of the present disclosure.

FIG. 3 illustrates an example of a flowchart that supports selecting an LCP procedure for data transmission in accordance with aspects of the present disclosure.

FIG. 4 illustrates an example of a block diagram of a device that supports COT sharing for an unlicensed sidelink channel in accordance with aspects of the present disclosure.

FIG. 5 illustrates a flowchart of a method that supports performing an LCP procedure using a shared COT in accordance with aspects of the present disclosure.

FIG. 6 illustrates a flowchart of a method that supports transmitting COT sharing information in accordance with aspects of the present disclosure.

### DETAILED DESCRIPTION

When a UE utilizes a COT to communicate (e.g., sidelink) over an unlicensed channel, the UE may share the COT with other UEs when the UE does not intend to utilize the COT for an entire duration of the COT. In some cases, a UE that uses the shared COT of an COT initiating UE may be able to perform a short LBT procedure (e.g., a type 2 procedure) to gain access to the shared COT.

However, the use of the shared COT for certain transmissions (e.g., physical sidelink shared channel (PSSCH) transmissions) may be based on certain conditions associated with a UE being eligible to utilize resource block (RB) sets within the shared COT for PSSCH transmission or others (e.g., physical sidelink control channel (PSCCH) transmissions).

For example, only PSSCH transmissions associated with a certain destination and/or channel access priority class (CAPC) may use RB sets over the shared COT. Thus, in some cases, a UE may have data available for transmission that satisfies shared COT conditions, but legacy Logical Channel Prioritization (LCP) procedures may prevent the use of the shared COT due to the data transmission not satisfying the destination and/or CAPC conditions, among other problems.

The systems and methods described herein enable an efficient sidelink LCP procedure by implementing an LCP procedure for sidelink communications that is based on received COT sharing indications. For example, the LCP procedure can identify and utilize sidelink logical channels of a shared COT based on a received indication of the shared COT and transmit data via the shared COT using the sidelink logical channels that satisfy the LCP procedure conditions. Further, by receiving the indication of the shared COT, the UE may perform a type 2 LBT procedure when accessing the shared channel.

Thus, the systems and methods can enable implementation of efficient sidelink LCP procedures over a shared COT, among other benefits.

Aspects of the present disclosure are described in the context of a wireless communications system. Aspects of the present disclosure are further illustrated and described with reference to device diagrams and flowcharts.

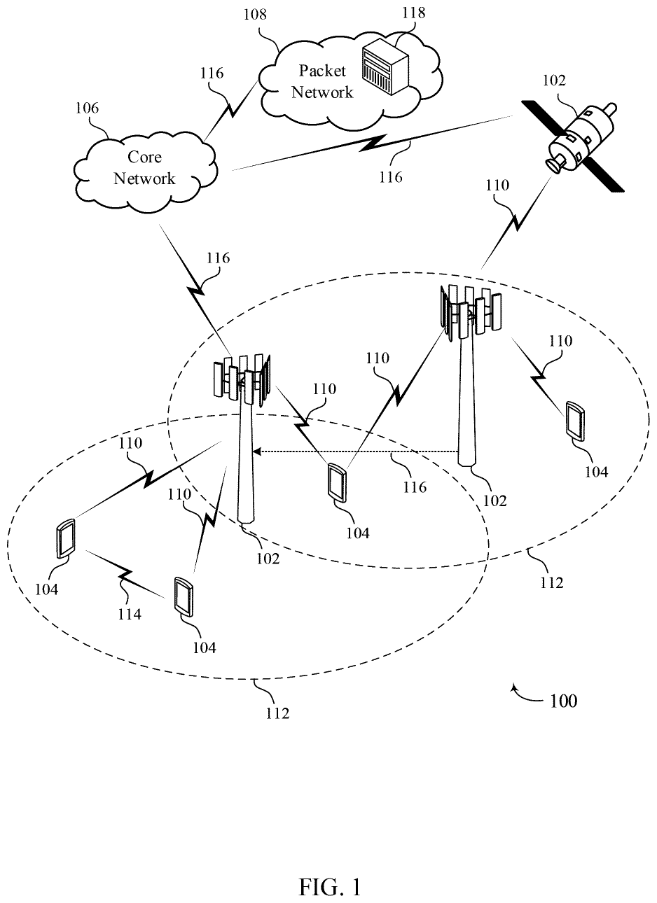

FIG. 1 illustrates an example of a wireless communications system 100 that supports COT sharing for an unlicensed sidelink channel in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, in some embodiments, a UE can utilize an enhanced or modified LCP procedure when transmitting data (e.g., PSSCH or PSCCH transmission) over a shared COT. For example, when a UE determines that the highest priority data in its buffer available for transmission has a higher priority than a predefined threshold priority, the UE may employ a legacy LCP procedure, where a destination of a sidelink transmission is selected based on the highest priority data.

However, when the highest priority of the data available for transmission is below the predefined threshold priority, the UE may use an enhanced LCP procedure, as described herein. In some cases, the enhanced LCP procedure is based on COT sharing information received from an initiating UE (e.g., information within an indication of a shared COT). Using the enhanced LCP procedure, the UE can access the shared COT and maximize usage of the shared COT.

For example, the UE may determine the highest priority as a highest priority among priorities of logical channels that have data available and that can be multiplexed in a transport block/medium access control (TB/MAC) protocol data unit (PDU), according to mapping restrictions (e.g., restrictions as described in clause 5.4.3.1.2 of TS 38.321). In some cases, a network (e.g., a gNB) can configure the UE with the predefined threshold priority via radio resource control (RRC) signaling.

In some cases, a responding UE, which uses resources over a shared COT (e.g., after type 2 LBT procedure access to the shared COT), can be a UE that is/was targeted by a COT initiating UE with PSCCH/PSSCH transmissions. For example, when the COT initiating UE performs a unicast transmission, the UE may be a responding UE when source and destination IDs within the indication of the shared COT match corresponding destination and source IDs at the receiving UE. As another example, when the COT initiating UE performs a groupcast or broadcast transmission, the UE may be the responding UE when source and destination IDs within the indication of the shared COT match a destination ID known by the receiving UE.

In some cases, the COT sharing information may include additional IDs that map to or match an ID for the responding UE, to satisfy the destination condition for transmitting data over the shared COT. Further, the COT sharing information may include a CAPC value (e.g., a threshold value) for transmitting data over the shared COT. Thus, the responding UE can use the shared COT to transmit data when the destination condition is satisfied and when data/transport block/MAC PDU to be transmitted over a sidelink by the responding UE (e.g., data within a buffer of the UE) has a CAPC value that is equal to or smaller than the CAPC value indicated within the COT sharing information.

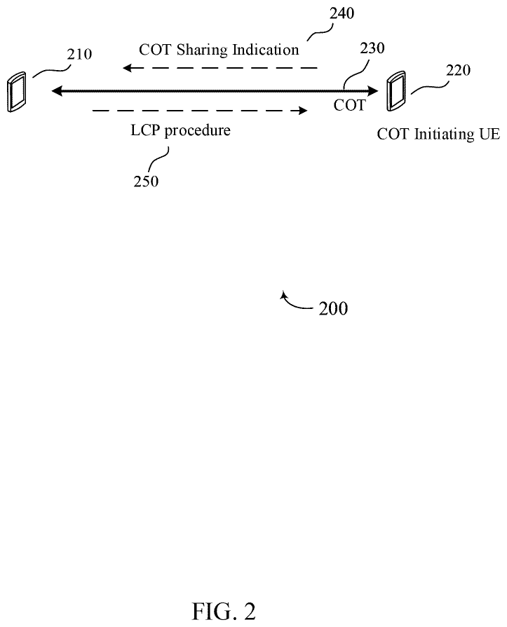

FIG. 2 illustrates an example of a wireless communications system 200 that supports performing an LCP procedure over a shared COT in accordance with aspects of the present disclosure. The wireless communications system 200 may implement or be implemented by aspects of the wireless communications system 100 as described in FIG. 1. For example, the wireless communications system 200 may include a base station 102 and a UE 104, which may be examples of base stations and UEs 104 as described with reference to FIG. 1.

A responding UE 210 receives an indication of a shared COT (e.g., a COT sharing indication 240) from a COT initiating UE 220, which initiated a COT 230 over an unlicensed channel for sidelink communications. As described herein, the COT sharing indication 240 may include, among other information, destination information and/or a CAPC value for data to be transmitted over the shared COT 230 by the responding UE 210.

The responding UE 210, having data to be transmitted that satisfies LCP procedure conditions for using the shared COT 230, can perform an LCP procedure 250 using the shared COT 230. For example, the responding UE 210 may determine that the highest priority data in its buffer that is available for transmission has a priority that is less than a predefined threshold priority.

Based on the determination, the responding UE 210 only utilizes logical channels (LCHs) that satisfy the CAPC condition during the LCP procedure 250. Thus, the responding UE 210 uses logical channels having associated CAPC values that are less than or equal to the CAPC value identified within the COT sharing information (e.g., contained in the COT sharing indication 240).

Further, the responding UE 210 may utilize logical channels that also satisfy the destination condition. For example, during the LCP procedure 250, the responding UE 210 uses logical channels having source and destination ID that match the destination and source ID(s) of the PSSCH/PSCCH of the COT initiating UE or contained in the COT sharing indication 240.

In some embodiments, the responding UE 210 may determine whether any data in its buffer that is available for transmission satisfies the destination condition for shared COT usage. For example, whether the responding UE 210 has PSSCH/PSCCH transmission(s) intended for the COT initiating UE 220, e.g., the source and destination IDs contained in the COT initiator's Sidelink Control Information (SCI) match to the corresponding destination and source IDs relating to the same unicast at the receiving UE.

In some cases, when no logical channel has data available for transmission that satisfies the destination condition for sharing the COT, the responding UE 210 may use a legacy LCP procedure. For example, the responding UE 210 generates a TB, and perform a LBT type 1 access procedure for transmission of the generated TB (e.g., without using any RB set(s) corresponding to the shared COT 230).

In other cases, when at least one logical channel includes data available for transmission that satisfies the destination condition (e.g., transmission to the destination is indicated to be in the shared COT 230), the responding UE 210 determines whether a delay budget associated with logical channels having data available for transmission that do not satisfy the destination condition can be satisfied, even though the shared COT 230 cannot be used for transmission of such data.

For example, the responding UE 210 determines whether the remaining delay budget of the logical channels that do not satisfy the destination condition is greater than a predefined threshold delay budget (e.g., a duration of the shared COT 230). When the responding UE 210 determines that a latency requirement of the data can be fulfilled, the responding UE 210 considers only those LCH(s) when determining a destination as part of an LCP procedure for a sidelink transmission that satisfies the destination condition (e.g., transmission to the destination ID is indicated to be in a shared COT). In some cases, the responding UE 210 may only consider logical channels during the destination selection that satisfy the CAPC condition (e.g., when the CAPC value associated with the logical channel is equal to or less than the CAPC value indicated within the COT sharing information of the COT sharing indication 240).

In some embodiments, the responding UE 210, as part of the destination selection of the LCP procedure, may only select/consider logical channels that satisfy the CAPC condition (e.g., logical channels having CAPC values that are less than or equal to a threshold CAPC value). For example, the responding UE 210 may determine whether the selected destination (e.g., the highest priority logical channel among the logical channels eligible for destination selection) satisfies the destination condition.

When the destination condition is not satisfied, the responding UE 210 may utilize a legacy LCP procedure (e.g., perform LBT type 1 for the transmission of the generated TB on PSSCH). However, when the selected destination satisfies the destination condition of the shared COT 230, the responding UE 210 generates the TB based on logical channels that satisfy the CAPC condition (and other conditions, such as LCH mapping restrictions) The responding UE 210 may then use LBT type 2 for the generated TB, and thus perform an enhanced LCP procedure for transmission of data via the shared COT 230.

In some embodiments, the responding UE 210, during an LCP procedure, selects/considers logical channels that satisfy the destination condition (e.g., corresponding PSSCH/PSCCH transmission is intended for the COT initiating UE 220) for a first sidelink transmission (e.g., PSSCH/PSCCH transmission) within the shared COT 230. For example, the responding UE 210 may only apply the destination restriction for a first PSSCH/PSCCH transmission within a shared COT 230.

Further the responding UE 210 may only select/consider logical channels that satisfy the CAPC condition for the first PSSCH/PSCCH transmission within the shared COT 230. For any remaining or subsequent PSSCH/PSCCH transmission(s) within the shared COT 230, the responding UE 210 may follow the legacy LCP procedure (e.g., use logical channels that don't satisfy the destination condition). In some cases, the responding UE 210 may apply the CAPC condition/restriction also for the subsequent PSSCH/PSCCH transmission(s) within the shared COT 230.

In doing so, the responding UE 210 can utilize the shared COT 230 (e.g., PSSCH/PSCCH transmissions utilize RB sets of the shared COT 230), when at least one PSSCH/PSCCH transmission is intended for the COT initiating UE 220, such as the first PSSCH/PSCCH transmission.

Further, in some cases, the responding UE 320 may determine whether there is data available for transmission that is intended for the COT initiating UE 220 before determining whether to use the shared COT 230 (via LBT type 2) or to initiate a new COT (via LBT type 1). When the first PSSCH/PSCCH transmission is to the COT initiating UE 220, the responding UE 210 can utilize the shared COT 230, and the responding UE 210 can perform subsequent transmissions to other UEs.

In some embodiments, the responding UE 210 may increase the CAPC value of a logical channel or a transport block when a delay budget of the logical channel or transport block is about to expire and CAPC restrictions/conditions do not allow for transmission of the transport block or logical channel using the shared COT 230. To ensure the responding UE 210 can transmit a TB within its delay budget by using the shared COT 230 (via LBT type 2), the responding UE 210, in some cases, may increase the CAPC priority of logical channel or TB. For example, the responding UE 210 may only increase the CAPC priority of a logical channel or TB to satisfy a CAPC condition of the shared COT 230 when the priority (e.g., a CAPC value) of the logical channel or TB is greater than a predefined threshold CAPC value.

In some embodiments, a buffer of the responding UE 210 has data of a sidelink logical channel available for transmission. However, the responding UE 210 may not multiplex MAC service data units (MAC SDU(s)) into a MAC PDU when a sidelink logical channel has a CAPC value that is greater than the CAPC value indicated within the COT sharing information, such as when the MAC PDU contains MAC SDU(s) of a sidelink logical channel having a high CAPC priority (e.g., SRB) and/or MAC CE(s), or when the TB contains MAC SDU(s) of the sidelink logical channel where the delay budget is about to expire and cannot be fulfilled without the shared COT 230.

To avoid the responding UE 210 using a low CAPC value (e.g., higher CAPC value than the CAPC value indicated within the shared COT information) for the transmission of a MAC PDU, and hence using LBT type 1 for the PSSCH/PSCCH transmission, the responding UE 210 may implement multiplex padding into the MAC PDU, instead of data of a logical channel having a low CAPC priority (e.g., high CAPC value). In some cases, the lowest priority CAPC of the logical channel(s) with MAC SDU multiplexed in the TB may be used for the transmission of a TB, regardless of whether the TB also contains sidelink MAC CEs in addition to MAC SDUs.

In some cases, the responding UE 210 may only implement multiplex padding into a MAC PDU when the amount of data having the highest CAPC priority within the MAC PDU exceeds or is greater than a certain size threshold, such as a value or a percentage (e.g., configured via higher layer signaling).

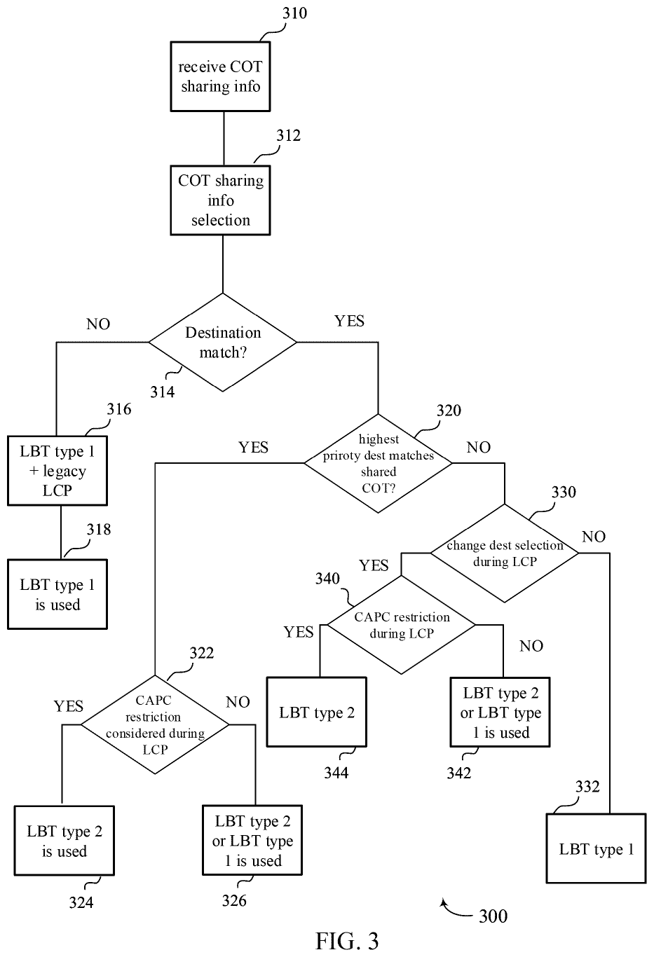

In some embodiments, the responding UE 210, as described herein, may perform a series of determinations when selecting an LCP procedure for transmission of data. FIG. 3 illustrates an example of a flowchart 300 that supports selecting an LCP procedure for data transmission in accordance with aspects of the present disclosure.

The responding UE 210 receives COT sharing information 310 and performs a COT sharing selection 312. First, the responding UE performs a destination match operation 314, and determines whether its buffer contains data available for transmission that fulfills the destination condition of the COT sharing information 310.

When there is no data available for transmission that satisfies the destination condition, the responding UE 210 follows a legacy LCP procedure 316 and performs LBT type 1 for corresponding PSSCH/PSCCH transmission(s). When there is data in the UEs buffer that satisfies the destination condition of the COT sharing information 310, the responding UE 210 determines, operation 320, whether the selected destination (when using the legacy LCP/destination selection based on the highest priority data) satisfies the destination condition of the shared COT.

When the selected destination satisfies the destination condition of the shared COT, the responding UE 210 determines, in operation 322, whether the CAPC condition is satisfied for PSSCH/PSCCH transmissions. When the responding UE 210 only uses logical channels during the LCP procedure, for the selected destination, which also satisfy the CAPC condition, the responding UE 210 is eligible to use the shared COT, and performs, in operation 324, LBT type 2. When the responding UE 210 does not apply an additional CAPC restriction during the LCP procedure, a resulting TB may not satisfy the CAPC condition of the shared COT, and the responding UE 210, in operation 326, performs LBT type 1.

When the selected destination does not satisfy the destination condition of the shared COT, the responding UE 210, in operation 330, determines whether to change the destination selection during the LCP procedure. The responding UE 210 may determine whether to change the destination selection based on the priority of the highest priority data within its buffer.

When the responding UE 210 selects a destination that does not satisfy the destination condition of the shared COT, the responding UE 210 initiates its own COT for the corresponding PSSCH/PSCCH transmission and performs an LBT type 1 procedure. When the responding UE 210 determines to change the destination selection procedure (e.g., to only use logical channels that satisfy the destination condition of the shared COT, the responding UE 210, in operation 340, determines whether a CAPC restriction is applied to determine eligibility to use the shared COT.

When the responding UE 210, in operation 340, only uses logical channels during the LCP procedure, for the selected destination, which also satisfy the CAPC condition, the responding UE 210 is eligible to use the shared COT, and performs, in operation 344, LBT type 2. When the responding UE 210 does not apply an additional CAPC restriction during the LCP procedure, the responding UE 210, in operation 342, performs LBT type 1, as described herein.

Further, in some cases, when the responding UE 210 receives multiple COT sharing information from different COT initiating UEs and the responding UE 210 has data that satisfies multiple COT sharing conditions, the responding UE 210 may maximize high priority transmission and follow legacy principles of destination selection based on the highest priority.

In some embodiments, the responding UE 210 may enter a discontinuous reception state (e.g., a DRX state), where the responding UE 210 does not monitor PSCCH (SCI)/PSSCH for a certain source destination pair when the responding UE 210 is using a shared COT for that destination. For example, the responding UE 210 may stop monitoring PSCCH/PSSCH from the COT initiating UE 220 when the COT initiating UE 220 is sharing its COT (e.g., the COT 230, and the responding UE 210 is using the shared COT.

The responding UE 210, in some cases, may stop monitoring PSCCH/PSSCH while it uses the shared COT, because the COT initiating UE 220 is sharing its COT, and thus there is no data available for transmission to the responding UE 210. The responding UE 210, in some cases, may stop or pause all drx-related timers when the responding UE 210 uses the shared COT and stops monitoring PSCCH/PSSCH (e.g., the drx-related timers for the source destination pair for which it is using the shared COT).

Thus, in some embodiments, a UE (e.g., the responding UE 210) may implement or enter a DRX state when it receives a COT sharing indication from a COT initiating UE (e.g., the COT initiating UE 220) and uses the shared COT (e.g., the COT 230).

As described herein, in various embodiments, the systems and methods enable a UE to utilize enhanced LCP procedures when performing data transmissions using sidelink over unlicensed spectrum.

In some cases, the systems and methods can enable a UE to only consider using logical channels that satisfy CAPC restrictions during an LCP procedure, such as when a selected destination fulfils the destination condition, the UE uses the shared COT for PSSCH transmission(s), and otherwise UE initiates its own COT.

In some cases, the systems and methods can implement criteria/rules that govern whether a UE uses a shared COT with a changed or enhanced LCP procedure, or whether to the UR initiates its own COT. For example, depending on the priority of its highest priority data, the UE determines whether use of a shared COT is suitable when the highest priority data exceeds a predefined priority threshold, and the UE may transmit the high priority data using a new COT. As another example, depending on the delay budget of a sidelink logical channel or transport block, the UE determines whether to change the LCP procedure, to use a shared COT for PSSCH transmission(s).

In some cases, the systems and methods can implement an enhanced destination selection based on a shared COT for initial sidelink transmissions of the shared COT, without any restrictions for subsequent transmissions.

In some cases, the systems and methods can enable a UE to increase the CAPC priority of a transport block or logical channel or include padding when a delay budget is about to expire and shared COT usage would not be allowed based on current CAPC values.

In some cases, the systems and methods can enable a UE to stop drx ActiveTime based on COT sharing info/usage, such as when a responding UE is using the shared COT (where DRX occurs during the usage of the shared COT and/or drx related timers are stopped when using the shared COT).

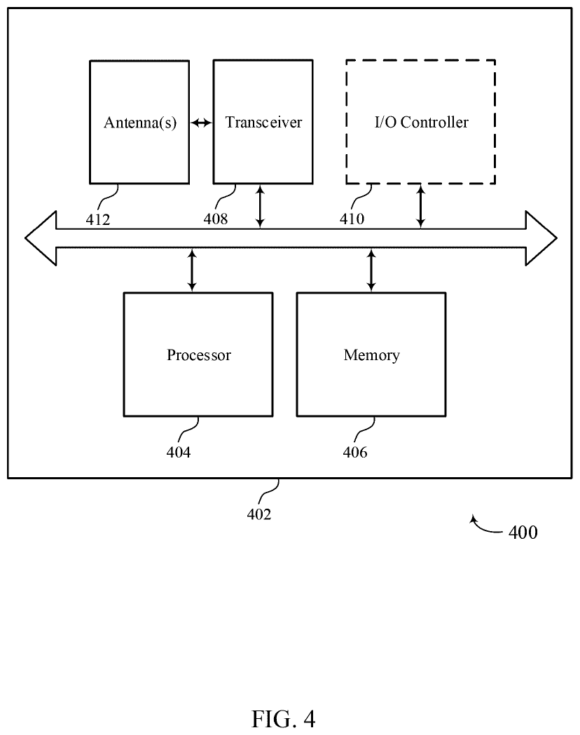

FIG. 4 illustrates an example of a block diagram 400 of a device 402 that supports COT sharing for an unlicensed sidelink channel in accordance with aspects of the present disclosure. The device 402 may be an example of a network entity 102 or UE 104 as described herein. The device 402 may support wireless communication with one or more network entities 102, UEs 104, or any combination thereof. The device 402 may include components for bi-directional communications including components for transmitting and receiving communications, such as a processor 404, a memory 406, a transceiver 408, and an I/O controller 410. These components may be in electronic communication or otherwise coupled (e.g., operatively, communicatively, functionally, electronically, electrically) via one or more interfaces (e.g., buses).

The processor 404, the memory 406, the transceiver 408, or various combinations thereof or various components thereof may be examples of means for performing various aspects of the present disclosure as described herein. For example, the processor 404, the memory 406, the transceiver 408, or various combinations or components thereof may support a method for performing one or more of the operations described herein.

In some implementations, the processor 404, the memory 406, the transceiver 408, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 404 and the memory 406 coupled with the processor 404 may be configured to perform one or more of the functions described herein (e.g., executing, by the processor 404, instructions stored in the memory 406).

For example, the processor 404 may support wireless communication at the device 402 in accordance with examples as disclosed herein. The processor 404 may be configured as or otherwise support a means for receiving an indication of a shared COT from a COT initiating UE identified by a first identifier, initiating a sidelink communication over a sidelink channel with a set of other UEs over an unlicensed band associated with the shared COT, and performing an LCP procedure that comprises generating a sidelink transport block to be transmitted to the set of other UEs over the initiated sidelink channel, where the sidelink transport block comprises MAC SDUs of one or more sidelink logical channels, and where the LCP procedure utilizes sidelink logical channels of the one or more sidelink logical channels having an associated CAPC value that is equal to or smaller than a threshold CAPC value, and an associated destination identifier that matches the first identifier of the COT initiating UE.

As another example, the processor 404 may support wireless communication at the device 402 in accordance with examples as disclosed herein. The processor 404 may be configured as or otherwise support a means for initiating a COT over an unlicensed band for sidelink communications between a set of UEs and transmitting an indication of a shared COT to a recipient UE of the set of UEs, where the indication of the shared COT comprises COT sharing information, including an identifier of the UE, and a threshold CAPC value for sidelink logical channels utilized by the recipient UE during an LCP procedure over the shared COT.

The processor 404 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 404 may be configured to operate a memory array using a memory controller. In some other implementations, a memory controller may be integrated into the processor 404. The processor 404 may be configured to execute computer-readable instructions stored in a memory (e.g., the memory 406) to cause the device 402 to perform various functions of the present disclosure.

The memory 406 may include random access memory (RAM) and read-only memory (ROM). The memory 406 may store computer-readable, computer-executable code including instructions that, when executed by the processor 404 cause the device 402 to perform various functions described herein. The code may be stored in a non-transitory computer-readable medium such as system memory or another type of memory. In some implementations, the code may not be directly executable by the processor 404 but may cause a computer (e.g., when compiled and executed) to perform functions described herein. In some implementations, the memory 406 may include, among other things, a basic I/O system (BIOS) which may control basic hardware or software operation such as the interaction with peripheral components or devices.

The I/O controller 410 may manage input and output signals for the device 402. The I/O controller 410 may also manage peripherals not integrated into the device M02. In some implementations, the I/O controller 410 may represent a physical connection or port to an external peripheral. In some implementations, the I/O controller 410 may utilize an operating system such as iOS®, ANDROID®, MS-DOS®, MS-WINDOWS®, OS/2®, UNIX®, LINUX®, or another known operating system. In some implementations, the I/O controller 410 may be implemented as part of a processor, such as the processor M06. In some implementations, a user may interact with the device 402 via the I/O controller 410 or via hardware components controlled by the I/O controller 410.

In some implementations, the device 402 may include a single antenna 412. However, in some other implementations, the device 402 may have more than one antenna 412 (i.e., multiple antennas), including multiple antenna panels or antenna arrays, which may be capable of concurrently transmitting or receiving multiple wireless transmissions. The transceiver 408 may communicate bi-directionally, via the one or more antennas 412, wired, or wireless links as described herein. For example, the transceiver 408 may represent a wireless transceiver and may communicate bi-directionally with another wireless transceiver. The transceiver 408 may also include a modem to modulate the packets, to provide the modulated packets to one or more antennas 412 for transmission, and to demodulate packets received from the one or more antennas 412.

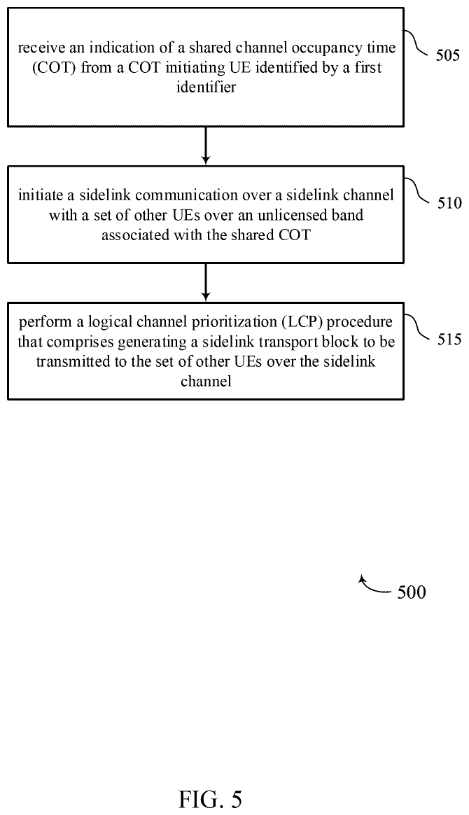

FIG. 5 illustrates a flowchart of a method 500 that supports performing an LCP procedure using a shared COT in accordance with aspects of the present disclosure. The operations of the method 500 may be implemented by a device or its components as described herein. For example, the operations of the method 500 may be performed by the UE 104 as described with reference to FIGS. 1 through 3. In some implementations, the device may execute a set of instructions to control the function elements of the device to perform the described functions. Additionally, or alternatively, the device may perform aspects of the described functions using special-purpose hardware.

At 505, the method 500 may include receiving an indication of a shared COT from a COT initiating UE identified by a first identifier. The operations of 505 may be performed in accordance with examples as described herein. In some implementations, aspects of the operations of 505 may be performed by a device as described with reference to FIG. 1.

At 510, the method 500 may include initiating a sidelink communication over a sidelink channel with a set of other UEs over an unlicensed band associated with the shared COT. The operations of 510 may be performed in accordance with examples as described herein. In some implementations, aspects of the operations of 510 may be performed by a device as described with reference to FIG. 1.

At 515, the method 500 may include performing an LCP procedure that comprises generating a sidelink transport block to be transmitted to the set of other UEs over the initiated sidelink channel, where the sidelink transport block comprises MAC SDUs of one or more sidelink logical channels, and where the LCP procedure utilizes sidelink logical channels of the one or more sidelink logical channels having an associated CAPC value that is equal to or smaller than a threshold CAPC value and an associated destination identifier that matches the first identifier of the COT initiating UE. The operations of 515 may be performed in accordance with examples as described herein. In some implementations, aspects of the operations of 515 may be performed by a device as described with reference to FIG. 1.

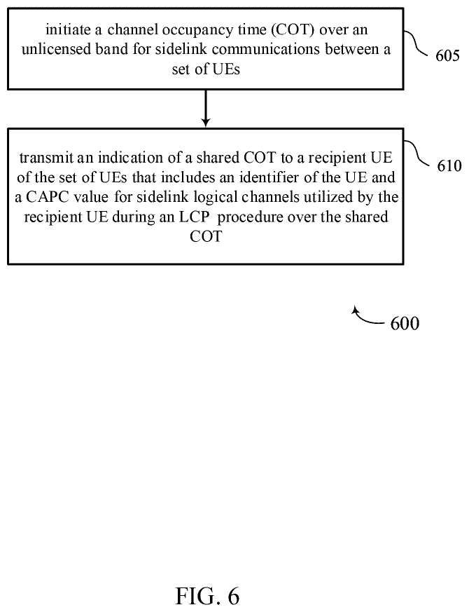

FIG. 6 illustrates a flowchart of a method 600 that supports transmitting COT sharing information in accordance with aspects of the present disclosure. The operations of the method 600 may be implemented by a device or its components as described herein. For example, the operations of the method 600 may be performed by the UE 104 as described with reference to FIGS. 1 through 3. In some implementations, the device may execute a set of instructions to control the function elements of the device to perform the described functions. Additionally, or alternatively, the device may perform aspects of the described functions using special-purpose hardware.

At 605, the method 600 may include initiating a COT over an unlicensed band for sidelink communications between a set of UEs. The operations of 605 may be performed in accordance with examples as described herein. In some implementations, aspects of the operations of 605 may be performed by a device as described with reference to FIG. 1.

At 610, the method 600 may include transmitting an indication of a shared COT to a recipient UE of the set of UEs, where the indication of the shared COT comprises COT sharing information, including an identifier of the UE and a threshold CAPC value for sidelink logical channels utilized by the recipient UE during a LCP procedure over the shared COT. The operations of 610 may be performed in accordance with examples as described herein. In some implementations, aspects of the operations of 610 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE), comprising:
at least one memory; and
at least one processor coupled with the at least one processor and configured to cause the UE to:
receive an indication of a shared channel occupancy time (COT) from a COT initiating UE identified by a first identifier;
initiate a sidelink communication over a sidelink channel with a set of other UEs over an unlicensed band associated with the shared COT; and
perform a logical channel prioritization (LCP) procedure that comprises generating a sidelink transport block to be transmitted to the set of other UEs over the sidelink channel,
wherein the sidelink transport block comprises media access channel service data units (MAC SDUs) of one or more sidelink logical channels; and
wherein the LCP procedure utilizes sidelink logical channels of the one or more sidelink logical channels having:
an associated channel access priority class (CAPC) value that is equal to or smaller than a threshold CAPC value, and
an associated destination identifier that matches the first identifier of the COT initiating UE.

2. The UE of claim 1, wherein the UE receives the threshold CAPC value from COT sharing information within the indication of the shared COT.

3. The UE of claim 1, wherein the sidelink logical channels considered during the LCP procedure are associated with CAPC values that are equal to or smaller than the threshold CAPC value.

4. The UE of claim 1, wherein the UE performs the LCP procedure based at least in part on the destination identifier of the sidelink logical channels utilized during the LCP procedure.

5. The UE of claim 1, wherein the utilized sidelink logical channels include sidelink traffic channels (STCH(s)).

6. The UE of claim 1, wherein each associated CAPC value for a logical channel is based on delay requirements of the logical channel.

7. The UE of claim 1, wherein the UE initiates the sidelink channel with the set of other UEs by selecting a sidelink grant.

8. A method performed by a user equipment (UE), the method comprising:
receiving an indication of a shared channel occupancy time (COT) from a COT initiating UE identified by a first identifier;
initiating a sidelink communication over a sidelink channel with a set of other UEs over an unlicensed band associated with the shared COT; and
performing a logical channel prioritization (LCP) procedure that comprises generating a sidelink transport block to be transmitted to the set of other UEs over the initiated sidelink channel,
wherein the sidelink transport block comprises media access channel service data units (MAC SDUs) of one or more sidelink logical channels; and
wherein the LCP procedure utilizes sidelink logical channels of the one or more sidelink logical channels having:
an associated channel access priority class (CAPC) value that is equal to or smaller than a threshold CAPC value, and
an associated destination identifier that matches the first identifier of the COT initiating UE.

9. The method of claim 8, wherein the UE receives the threshold CAPC value from COT sharing information within the indication of the shared COT.

10. The method of claim 8, wherein the sidelink logical channels considered during the LCP procedure are associated with CAPC values that are equal to or smaller than the threshold CAPC value.

11. The method of claim 8, wherein the UE performs the LCP procedure based at least in part on the destination identifier of the sidelink logical channels utilized during the LCP procedure.

12. The method of claim 8, wherein the utilized sidelink logical channels include sidelink traffic channels (STCH(s)).

13. The method of claim 8, wherein each associated CAPC value for a logical channel is based on delay requirements of the logical channel.

14. The method of claim 8, wherein the UE initiates the sidelink channel with the set of other UEs by selecting a sidelink grant.

15. A user equipment (UE), comprising:
at least one memory; and
at least one processor coupled with the at least one processor and configured to cause the UE to:
initiate a channel occupancy time (COT) over an unlicensed band for sidelink communications between a set of UEs; and
transmit an indication of a shared COT to a recipient UE of the set of UEs,
wherein the indication of the shared COT comprises COT sharing information, including:
an identifier of the UE; and
a threshold channel access priority class (CAPC) value for sidelink logical channels utilized by the recipient UE during a logical channel prioritization (LCP) procedure over the shared COT.

16. The UE of claim 15, wherein the UE transmits the indication of the shared COT via radio resource control (RRC) signaling.

17. A processor for wireless communication, comprising:
at least one controller coupled with at least one memory and configured to cause the processor to:
receive an indication of a shared channel occupancy time (COT) from a COT initiating UE identified by a first identifier;
initiate a sidelink communication over a sidelink channel with a set of other UEs over an unlicensed band associated with the shared COT; and
perform a logical channel prioritization (LCP) procedure that comprises generating a sidelink transport block to be transmitted to the set of other UEs over the sidelink channel,
wherein the sidelink transport block comprises media access channel service data units (MAC SDUs) of one or more sidelink logical channels; and
wherein the LCP procedure utilizes sidelink logical channels of the one or more sidelink logical channels having:
an associated channel access priority class (CAPC) value that is equal to or smaller than a threshold CAPC value, and
an associated destination identifier that matches the first identifier of the COT initiating UE.

18. The processor of claim 17, wherein the processor receives the threshold CAPC value from COT sharing information within the indication of the shared COT.

19. (canceled)

20. (canceled)

21. The UE of claim 1, wherein the UE receives, from COT sharing information within the indication of the shared COT, identifiers that map to an identifier of a responding UE from the set of other UEs.

22. The method of claim 8, wherein COT sharing information within the indication of the shared COT includes identifiers that map to an identifier of a responding UE from the set of other UEs.
